(19) United States
(12) Patent Application Publication
(10) Pub. No.: US 2026/0192570 A1
(43) Pub. Date: Jul. 9, 2026

(54) Non-Recirculating Ink Supply System and Method for Waterless Digital Printing on Uncoated Textiles

(71) Applicant: Taner Can Guven, KENNESAW, GA (US)

(72) Inventor: Taner Can Guven, KENNESAW, GA (US)

(21) Appl. No.: 19/551,629

(22) Filed: Feb. 27, 2026

(51) Int. Cl. B41J 2/175; B41J 2/19; B41J 3/407; D06P 5/30

(52) U.S. Cl. CPC B41J 2/17596; B41J 2/17563; B41J 2/17566; B41J 2/19; B41J 3/4078; D06P 5/30

(57) ABSTRACT

A method and system for waterless digital printing on uncoated textile substrates using pigmented inks are disclosed. The system includes a main ink tank, ink pump, filtration unit, degassing unit, and a subtank supplying ink directly to a piezoelectric inkjet printhead through a manual or mechanical valve. During printing, ink supplied from the subtank to the printhead is not recirculated, and no solenoid valves or electronically actuated flow control components act on the ink within the printhead feed path. By eliminating recirculation and electronic actuation, heat generation and mechanical agitation are reduced, preventing premature binder activation, pigment destabilization, and sedimentation. The disclosed architecture enables stable use of mid-high viscosity pigmented inks for high-quality, waterless digital printing on uncoated textiles.

### FIELD OF THE INVENTION

The present invention relates to digital textile printing, and more particularly to methods and systems for waterless digital printing on uncoated textile substrates. The invention is directed to an ink supply architecture configured to deliver pigmented inks to digital inkjet printheads while reducing heat generation and mechanical agitation within the ink delivery path.

### BACKGROUND OF THE INVENTION

Digital textile printing has advanced significantly in recent years; however, conventional printing processes remain heavily dependent on water-intensive workflows, particularly when printing on uncoated textile substrates. Reactive and dye-based printing processes typically require fabric pre-treatment, extensive washing, and post-processing steps, resulting in high water consumption, chemical usage, and energy demand.

Pigmented inks have been increasingly explored as an alternative due to their ability to print directly onto uncoated textiles without post-printing washing. However, pigmented ink formulations—especially those designed to achieve high color strength and durability—often require increased pigment loading, stronger binder systems, and medium-to-high viscosity. These formulations are highly sensitive to thermal exposure and mechanical agitation.

Conventional ink supply systems commonly rely on continuous ink recirculation and electronically actuated flow control components, such as solenoid valves, to maintain ink readiness and regulate delivery to the printhead. Such systems inherently generate heat through electrical actuation, fluid friction, and continuous mechanical motion. Exposure of thermally sensitive pigmented inks to these conditions can result in premature binder activation, pigment agglomeration, and sedimentation within the ink delivery pathway.

Sedimentation and ink instability lead to inconsistent ink delivery, nozzle misfiring, clogging, and accelerated degradation of printheads and associated components. As a result, conventional ink supply architectures impose significant constraints on ink formulation, forcing the use of weaker binders, reduced pigment concentrations, or lower viscosities, which ultimately produces print quality inferior to that of water-intensive reactive dye processes.

Attempts to address these issues have generally focused on improved recirculation control, active cooling, or electronic flow modulation. However, such approaches continue to rely on thermally active components and continuous ink movement, and therefore fail to address the underlying incompatibility between conventional pressurized ink delivery architectures and thermally sensitive pigmented ink formulations.

Accordingly, there exists a need for an ink delivery system and method that enables stable delivery of pigmented inks to digital printheads without recirculation or electronically actuated flow control components, thereby allowing the use of more robust ink formulations while achieving high-quality, waterless printing on uncoated textile substrates.

### SUMMARY OF THE INVENTION

The present invention provides a method and system for waterless digital printing on uncoated textile substrates using aqueous pigmented ink formulations, wherein ink stability is maintained by reducing heat generation and mechanical stress within the ink delivery pathway. The invention is particularly directed to an ink supply architecture that enables reliable delivery of mid-high viscosity, pigmented inks by avoiding ink recirculation and eliminating electronically actuated flow control components in the printhead feed stage. As used herein, “mid-to-high viscosity” refers to an aqueous pigmented ink formulation exhibiting a viscosity of approximately 6 to 35 centipoise (cP), measured at a temperature between 20° C. and 35° C., while remaining jettable through a piezoelectric drop-on-demand printhead,

In one embodiment, ink is supplied from a main ink tank through an ink pump, a filtration unit, and a degassing unit, and is then introduced into a subtank that functions as an intermediate ink reservoir feeding one or more digital inkjet printheads. Ink flow from the subtank to the printhead is controlled using manual or mechanical valves rather than solenoid valves or other electronically actuated components.

During printing, ink supplied from the subtank to the printhead is not recirculated, and no solenoid valves or continuously operating pumps act on the ink within the printhead feed path. By eliminating recirculation and solenoid-based actuation, the system reduces heat input and mechanical agitation, preventing premature binder activation, pigment destabilization, and sedimentation.

This architecture enables the use of pigmented ink formulations having increased pigment loading, stronger binder systems, and medium-to-high viscosity, thereby allowing printed textiles to achieve color strength, visual uniformity, and durability comparable to water-intensive reactive dye printing processes without requiring fabric pre-treatment or post-printing washing.

### BRIEF DESCRIPTION OF THE DRAWING

FIG. 1 is a schematic diagram of a digital textile printing system incorporating an ink supply architecture in accordance with one embodiment of the invention, illustrating a main ink tank, ink pump, filtration unit, degassing unit, subtank, manual or mechanical valve, negative pressure generator, piezoelectric inkjet printhead, negative pressure regulator, positive pressure regulator, and safety tank.

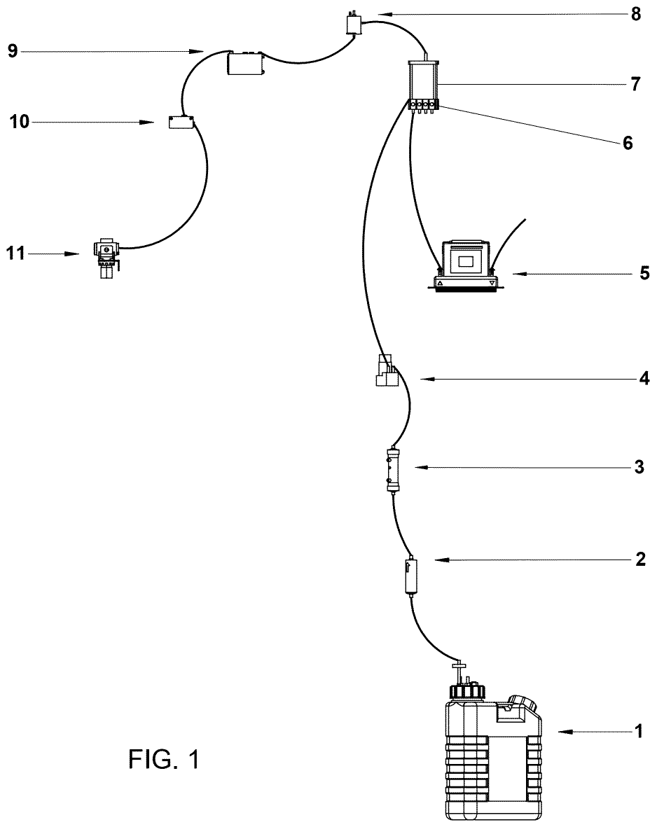

### DETAILED DESCRIPTION OF THE INVENTION

The current invention is further illustrated by the following embodiments.

### Embodiment 1

The Digital Textile Printing System of the Current Invention Is Illustrated As follows:

A main ink tank 1 stores a pigmented ink formulation suitable for digital textile printing. The ink is delivered from the main ink tank 1 by an ink pump 4 to a filtration unit 2 configured to remove particulate contaminants. Filtered ink is then supplied to a degassing unit 3 configured to remove entrained air and dissolved gases.

Conditioned ink exiting the degassing unit 3 is introduced into an intermediate subtank 7 configured to function as a local ink reservoir supplying ink directly to a piezoelectric inkjet printhead 5. The subtank 7 is formed of a chemically inert material relative to the aqueous pigmented ink formulation and is configured to hold ink without active stirring, recirculation, or heat-generating flow control components. In certain embodiments, the subtank comprises glass.

Ink flow from the subtank 7 to the printhead 5 is controlled by one or more manual or mechanical valves 6 that are not electronically actuated. The subtank is positioned at an elevation relative to the printhead such that ink delivery is assisted by gravity, providing a stable baseline driving force for ink flow without the need for continuous pumping in the printhead feed path.

A negative pressure generator 10 cooperates with a negative pressure regulator 9 and a positive pressure regulator 11 to maintain stable meniscus pressure at the printhead. This pressure regulation allows precise control of ink delivery and droplet formation while avoiding continuous ink circulation between the subtank 7 and the printhead 5. A safety tank 8 protects the system from overpressure conditions.

Importantly, ink supplied from the subtank 7 to the printhead 5 is not recirculated during printing, and no solenoid valves, electronically actuated flow control components, or continuously operating pumps act on the ink within this portion of the ink delivery path. By eliminating electrically actuated valves and continuous circulation in the printhead feed stage, localized heat generation and mechanical agitation are substantially reduced.

The reduced thermal and mechanical stress within the ink delivery path prevents premature activation of ink binders, destabilization of pigment dispersions, and sedimentation. As a result, the system enables stable delivery of pigmented inks having increased pigment loading, stronger binder systems, and medium-to-high viscosity, which would otherwise be incompatible with conventional recirculating or solenoid-actuated ink supply systems.

In an alternative embodiment, the intermediate subtank 7 may be formed of any material that is chemically inert relative to the aqueous pigmented ink formulation and that minimizes undesirable thermal interaction with the ink. While glass is a preferred embodiment due to its chemical stability and low reactivity, the subtank may alternatively comprise polyethylene (PE), polypropylene (PP), fluoropolymer-lined materials, ceramic materials, quartz, composite polymers, coated metals, or other materials that do not chemically react with or destabilize the ink formulation.

The subtank 7 may be configured with transparent walls to permit visual monitoring of ink level and sedimentation behavior, or alternatively may include level sensors, load cells, or differential pressure sensors for automated monitoring of ink volume without active recirculation.

The inkjet printhead 5 may comprise a piezoelectric drop-on-demand printhead in preferred embodiments. In alternative embodiments, the printhead may comprise a thermal inkjet printhead or other inkjet actuation mechanisms suitable for jetting aqueous pigmented ink formulations within the viscosity ranges described herein.

The manual or mechanical valves 6 may comprise gravity-actuated valves, needle valves, diaphragm valves, or other non-electronically actuated flow control mechanisms that do not generate significant localized heat during operation. In certain embodiments, gravity-assisted ink delivery may be supplemented by controlled static head height adjustment to fine-tune baseline pressure.

In a practical implementation of this embodiment, the system was used to print directly onto uncoated polyester textile using an aqueous pigmented ink formulation having a viscosity of approximately 9-11 centipoise measured at 25° C. The ink contained elevated pigment loading and binder concentration relative to conventional low-viscosity dye-based textile inkjet systems.

Printing was conducted without active ink recirculation between the subtank 7 and the printhead 5. During continuous operation, no premature binder activation, pigment agglomeration, or sedimentation-induced nozzle instability was observed. The resulting printed textile exhibited high color opacity, strong adhesion, and durability characteristics comparable to water-intensive reactive textile processes, while eliminating pre-treatment and water-intensive fixation stages.

This embodiment further demonstrates that maintaining the ink in a static, thermally stable state within the subtank prior to delivery to the printhead enables the use of more aggressive pigmented ink formulations that would otherwise be unstable in conventional recirculating or solenoid-actuated ink supply systems.

What is claimed is:

1. A digital textile printing system configured for printing on an uncoated textile substrate using a pigmented ink, said system comprising:
a main ink tank;
an ink pump connected to the main ink tank;
a subtank;
an inkjet printhead fluidly connected to the subtank;
a manual or mechanical valve positioned between the subtank and the printhead;
wherein the subtank is configured as an intermediate ink reservoir positioned at an elevation relative to the inkjet printhead;
wherein, during printing, the ink supplied from the subtank to the printhead is not recirculated; and
wherein no solenoid valves, electronically actuated flow control components, or continuously operating pump act on the ink between the subtank and the printhead.

2. The digital textile printing system of claim 1, wherein the system further comprising a filtration unit.

3. The digital textile printing system of claim 1, wherein the system further comprising a degassing unit.

4. The digital textile printing system of claim 1, wherein the system further comprising at least one of:
a negative pressure regulator;
a positive pressure regulator;
a negative pressure generator;
configured to maintain a substantially stable meniscus pressure in the subtank.

5. The digital textile printing system of claim 1, wherein the system further comprising a safety tank connected to the subtank.

6. The digital textile printing system of claim 1, wherein the subtank is configured to remain substantially static during printing.

7. The digital textile printing system of claim 1, wherein the manual or mechanical valve is configured to remain substantially fixed during printing.

8. The digital textile printing system of claim 1, wherein the system is configured to print mid to high viscosity pigmented inks.

9. The digital textile printing system of claim 1, wherein the inkjet printhead is a piezoelectric or thermal inkjet printhead.

10. The digital textile printing system of claim 1, wherein the subtank is configured to monitor ink level manually or automatically using transparent wall, level sensor, load cell, or differential pressure sensor.

11. A method for digital printing on an uncoated textile substrate using a pigmented ink, comprising:
supplying the pigmented ink from a main ink tank through an ink pump to a subtank configured as an intermediate ink reservoir;
supplying the ink from the subtank to an inkjet printhead;
controlling ink flow from the subtank to the printhead using a manual or mechanical valve that is not electronically actuated;
wherein the subtank is positioned at an elevation relative to the inkjet printhead;
wherein, during printing, the ink supplied from the subtank to the printhead is not recirculated; and
wherein no solenoid valves, electronically actuated flow control components, or continuously operating pump act on the ink between the subtank and the printhead.

12. The method for digital printing on an uncoated textile substrate of claim 10, wherein the method further comprising filtering the ink using a filtration unit.

13. The method for digital printing on an uncoated textile substrate of claim 10, wherein the method further comprising a degassing the ink using a degassing unit.

14. The method for digital printing on an uncoated textile substrate of claim 10, wherein the method further comprising:
maintain a substantially stable meniscus pressure in the subtank using at least one of:
a negative pressure regulator;
a positive pressure regulator;
a negative pressure generator.

15. The method for digital printing on an uncoated textile substrate of claim 10, wherein the method further comprising:
controlling the ink overflow using a safety tank connected to the subtank.

16. The method for digital printing on an uncoated textile substrate of claim 10, wherein the subtank is configured to remain substantially static during printing.

17. The method for digital printing on an uncoated textile substrate of claim 10, wherein the manual or mechanical valve is configured to remain substantially fixed during printing.

18. The method for digital printing on an uncoated textile substrate of claim 10, wherein the method is configured to print mid to high viscosity pigmented inks.

19. The method for digital printing on an uncoated textile substrate of claim 10, wherein the inkjet printhead is a piezoelectric or thermal inkjet printhead.

20. The method for digital printing on an uncoated textile substrate of claim 10, wherein the ink level in the subtank is monitored manually or automatically using transparent wall, level sensor, load cell, or differential pressure sensor.
